(19) United States
(12) Patent Application Publication
(10) Pub. No.: US 2012/0084223 A1
(43) Pub. Date: Apr. 5, 2012

(54) System To Organize Commodity-Product Distribution

(75) Inventors: Philippe Briet, Acheres (FR); Franck Mornet, Gif-sur-Yvette (FR); Jeremy Omer, Toulouse (FR)

(73) Assignee: L'Air Liquide Societe Anonyme Pour L'Etude Et L'Exploitation Des Procedes Georges Claude, Paris (FR)

(21) Appl. No.: 12/914,430

(22) Filed: Oct. 28, 2010

Related U.S. Application Data
(60) Provisional application No. 61/388,256, filed on Sep. 30, 2010.

(51) Int. Cl. G06Q 30/00

(52) U.S. Cl. 705/338

(57) ABSTRACT

Techniques are disclosed for generating a delivery schedule for distributing commodity products to a group of customers grouped by clusters. For example, a distributor/producer of refined gasses distributed via cylinders may create a proposed delivery schedule limiting the days at which product is delivered to different customers. A delivery planning application may include a clustering module a set of input data to generate a set of clusters representing groups of customers, e.g., using a Greedy Algorithm optimized using a Tabu search. Once the clusters are generated, a planning module may be used to affect trucks (or other delivery vehicles) to clusters. A truck affected to a given cluster by the delivery planning application is then scheduled to deliver cylinders to that cluster. The delivery schedule may provide a reusable two-week plan for servicing a group of customers in a supply chain network.

### CROSS-REFERENCE TO RELATED APPLICATIONS

This application claims the benefit of U.S. Provisional Application No. 61/388,256, filed Sep. 30, 2010, the entire contents of which are incorporated herein by reference.

### BACKGROUND

A supply chain generally refers to a system of organizations, people, technology, activities, information and resources involved in moving products (e.g., raw materials) from one point (such as a manufacturer's facility) to another (such as a customer's distribution or manufacturing center). For example, a supply chain may be used to describe the production and delivery of gaseous (or liquid) substances stored in pressurized tanks (often referred to as cylinders). In such a supply chain, a producer may generate product using an air separation unit (ASU) to separate atmospheric air into gaseous components (e.g., oxygen gas (O₂), nitrogen gas (N₂), hydrogen gas (H₂), Argon gas (Ar), etc.). The resulting purified gas may be made available (e.g., over a pipeline) at a filling station. And at the filing station, cylinders are filled, delivered to different customers, and returned (for refilling). Elements of this supply chain (i.e., the filling, delivering, retrieving and refilling cylinders) itself may be a component of other supply chains for the customers where the product is delivered. Such a supply chain uses the materials in the cylinders in manufacturing or other production activities, resulting in the creation and distribution of products to other customers.

Like other supply chains, optimizing a supply chain for a cylinder delivery and distribution network is a complex task. In particular, generating a delivery schedule that satisfies customer demand while attempting to minimize global cost frequently proves to be a difficult challenge as a producer/distributor typically has a very broad range of options for delivering product to customers. This fact makes it difficult for a producer/distributor to effectively determine how to schedule trucks to deliver cylinders to a set of customers (or even to determine how frequently to deliver to a given customer). Further, contractual arrangements may require that some customers be delivered cylinders at predefined schedules, which simply adds constraints to consider when creating a delivery schedule. At the same time, for even a moderately sized producer/distributor of refined gases, optimizing the manner in which cylinders are delivered to customers can provide a substantial benefit.

### SUMMARY

Embodiments of the invention provide a system for organizing cylinder deliveries. One embodiment of the invention includes a method for generating a delivery schedule for customers grouped by clusters. The method may generally include receiving a set of input data specifying a set of customers, delivery vehicles, and delivery parameters for distributing a commodity product to the set of customers from a filling plant or a hub using direct transport to customers called “secondary transport” at the opposite of “primary transport” used in the supply chain between plants and hubs. The method may also include generating, from the input data, a set of one or more clusters. Each cluster specifies a disjoint group of one or more of the customers and the disjoint group of one or more of the customers in a cluster represents a group of customers allowed to request deliveries on a common set of days of the week, and which are delivered by the same delivery vehicle on the common set of days of the week. The method also includes determining a delivery schedule for distributing the commodity product to the set of customers. The delivery schedule allocates one or more days of a week for a delivery to each cluster using one of the delivery vehicles.

Another embodiment includes a computer-readable storage medium containing a delivery scheduling application, which, when executed on a processor performs the method for generating a delivery schedule for a supply chain network set forth above.

Still another embodiment includes a system having a processor and a memory storing a delivery scheduling application, which when executed on the processor performs the method for generating a delivery schedule for a supply chain network set forth above.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers.

FIG. 1A illustrates an example of a distribution network for cylinder distribution to customers, according to one embodiment of the invention.

FIG. 1B illustrates an example delivery path between a cylinder delivery departure site and a customer cluster, according to one embodiment of the invention

FIG. 2 is a view of a computing system which includes a delivery scheduling application, according to one embodiment of the invention.

FIG. 3 illustrates components of the delivery scheduling application first shown in FIG. 2, according to one embodiment of the invention.

FIG. 4 illustrates a method for generating a delivery schedule for a cylinder distribution network, according to one embodiment of the invention.

FIG. 5 illustrates an element of the method shown in FIG. 4, according to one embodiment of the invention.

FIG. 6 illustrates an example workflow for a producer/distributor to organize a delivery schedule for a group of customers, according to one embodiment of the invention.

FIG. 7 illustrates an example two-week delivery schedule specifying days of the week for delivering cylinders to clusters of customers, according to one embodiment of the invention.

### DESCRIPTION OF PREFERRED EMBODIMENTS

As described in greater detail below, embodiments of the invention provide a computer-implemented delivery planning application configured to generate a schedule (e.g., a two-week schedule) for delivering a commodity product to multiple customers (e.g., cylinders of refined gasses). A producer (or distributor) may periodically use the delivery planning application to optimize a cylinder delivery schedule, which, in turn, reduces overall delivery costs. Further, as the producer (or distributor) typically supplies customers pursuant to longer-term contracts, the two-week schedule can be used (and re-used) over a longer period (e.g., six months). When it comes time to prepare a new delivery schedule (e.g., due to fluctuations in existing customer demand), the delivery application may be used to generate a new schedule. Similarly, while negotiating a contract with a new customer that would need to be added to the delivery schedule, the delivery application may generate a proposed schedule that the producer may use to negotiate a set of allowed delivery dates for the new customer, helping integrate the new customer into the existing delivery schedule in an efficient manner.

In one embodiment the delivery application generates a delivery schedule from a set of inputs (e.g., a set of customers, trucks, and delivery parameters). Using these inputs, the delivery application first generates a set of clusters, each representing a set of customers to which cylinders should be delivered to as a group (e.g., using a single truck). Once the clusters are generated, the delivery application generates a planning schedule for delivering cylinders to the customers in each cluster. That is, importantly, while customers typically need to maintain a certain delivery frequency (e.g., once a week, twice a week, etc.) the particular days of the week at which deliveries occur may be less important. This gives the delivery application flexibility to generate a delivery schedule assigning customer deliveries to specific days of the week. Accordingly, in one embodiment, the delivery schedule may specify a set of days of the week where deliveries can be scheduled for each customer over a two-week period. For example, the delivery schedule for a given customer may limit deliveries to specific days of the week (e.g., only Monday and Wednesday). Doing so can help drastically reduce the supply chain cost for the producer/distributor in delivering cylinders, provided the delivery days are well organized between customers.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified herein.

Additionally, the following description details an embodiment of the invention used to generate a schedule for delivering cylinders to multiple customers as an example of a supply chain that may be optimized using the techniques disclosed herein. However, it should be understood that embodiments of the invention may be adapted for use with a broad variety of supply chains with comparable characteristics, e.g., other commodity products delivered from a central distribution point on a regular basis. Accordingly, references to the delivery of cylinders storing refined gases (or vaporizable liquids) are provided to be illustrative and not limiting.

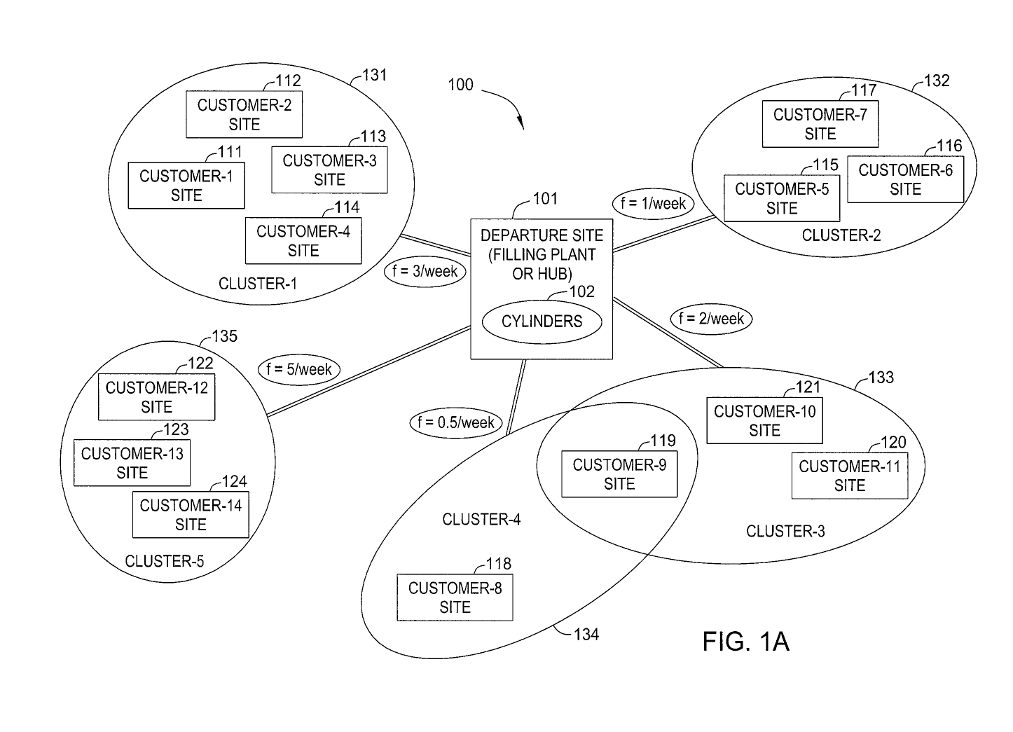

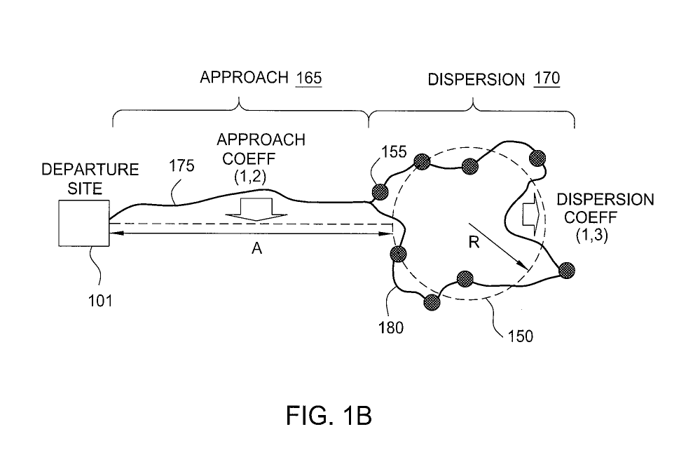

FIG. 1A illustrates an example of a distribution network 100 for cylinder distribution to customers, according to one embodiment of the invention. As shown, the distribution network 100 includes a departure site 101, i.e. a filling plant or a hub. A filling plant is a location where cylinders are filled and a hub is a site where cylinders may be stored, prior to distribution to customers. Note, while FIG. 1A shows a single departure site 101, one of skill in the art will recognize that distribution network 100 could include multiple departure sties (i.e., multiple filling plants and hubs). From the departure site 101, filled cylinders 102 are delivered to the customers 111, 112, 113, 114, 115, 116, 117, 118, 119, 120, 121, 122, 123, 124

Illustratively, the customers 111-124 are grouped into clusters 131, 132, 133, 134 and 135. A customer can belong to several clusters, as is the case for customer 119. Customers in multiple clusters have a delivery frequency equal to the sum of delivery frequencies of each cluster which they are a member. In one embodiment, a delivery planning application may generate the clusters and assign each cluster a frequency of delivery. The delivery planning application may also generate a schedule for deliveries per cluster per week. If a cluster is delivered Day 1 and Day 3, a truck goes into that cluster twice a week and can accordingly make a delivery to one or more other customers of this cluster on Day 1 and/or on Day 3. This could occur, e.g., for customers 119, 120, and 121 in cluster-3 133. In one embodiment, the delivery planning application may generate clusters that minimize an approach coefficient and a dispersion coefficient. For example, FIG. 1B shows departure site 101 along with an approach delivery route 175 and a cluster delivery route 180, according to one embodiment of the invention. The approach delivery route 175 corresponds to a path from the departure site 101 to a first customer in cluster 150 (customer 155 in this example) and the cluster delivery route 180 corresponds to the delivery path to distribute product to each customer associated with the cluster 150. The greater the approach and dispersion coefficients that results from grouping a given group of customers into a cluster, the less efficient that cluster is considered to be. Accordingly, generating clusters that minimize the approach and dispersion coefficients result in a more efficient delivery schedule.

Further, scheduling per cluster and per truck provides tactical help to administrators at an operations or planning center where the operations of the departure site 101 are managed. For example, the delivery schedule generated by the scheduling application may specify a set of allowed delivery days for each customer (i.e., over a two-week cycle). In such a case, a customer's orders are scheduled for delivery on the days specified during the two-week cycle for the cluster to which the customer belongs. More generally, the planning center 110 may generally be used to coordinate the activities of the departure site 101 in delivering cylinders to customer sites 111-124. For example, the planning center 110 may receive orders for filled cylinders 119 from the customers at customer sites 125₁₋₅, schedule such orders for delivery, as well as set and monitor production at production facility 105. In one embodiment, personnel at the planning center 110 may periodically use a computer-implemented delivery application to generate a delivery schedule specifying allowed delivery days for each customer (e.g., over a two week cycle). In such a case, customer orders are scheduled for delivery to a given customer site 125 on the days specified by the two week cycle for that customer.

Of course, some customers may have contracts (or orders) specifying recurring deliveries. In such a case, the planning center may repeatedly schedule deliveries to satisfy such contractual requirements (or orders) on the days specified by the two-week delivery cycle. Further, one of ordinary skill in the art will recognize that the presentation of a supply chain for a cylinder delivery network shown in FIG. 1A is simplified to highlight aspects of the present invention as well as that while described as generating a two-week delivery schedule for cylinders, the length of the delivery schedule generated using the techniques of the present invention may be adjusted to suit the needs of a particular supply chain or distribution network.

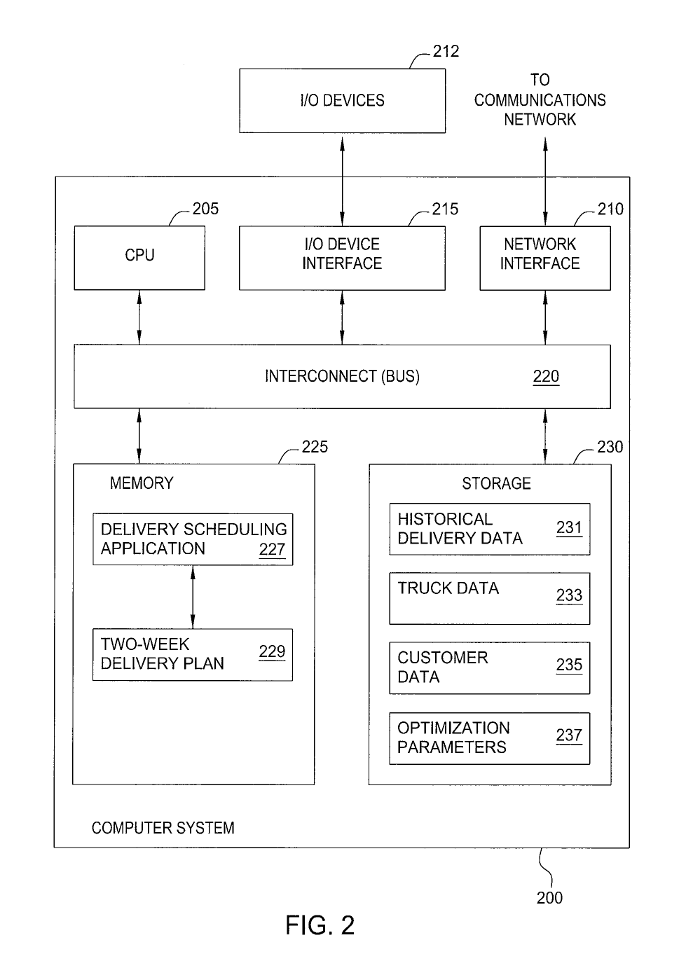

FIG. 2 is a more detailed view of a computer system 200 which includes the retail commodity manager of FIGS. 1A-1B, according to one embodiment of the invention. As shown, the computer system 200 includes, without limitation, a central processing unit (CPU) 205, a network interface 215, an interconnect 220, a memory 225, and storage 230. The computer system 200 may also include an I/O device interface 210 connecting I/O devices 212 (e.g., keyboard, display and mouse devices) to the computer system 200.

In general, the CPU 205 retrieves and executes programming instructions stored in the memory 225. Similarly, the CPU 205 stores and retrieves application data residing in the memory 225. The interconnect 220 facilitates transmission of programming instructions and application data between the CPU 205, I/O devices interface 210, storage 230, network interface 215, and memory 225. CPU 205 is included to be representative of a single CPU, multiple CPUs, a single CPU having multiple processing cores, and the like. And the memory 225 is generally included to be representative of a random access memory. The storage 230 may be a disk drive storage device. Although shown as a single unit, the storage 230 may be a combination of fixed and/or removable storage devices, such as fixed disc drives, floppy disc drives, tape drives, removable memory cards, optical storage, network attached storage (NAS), or a storage area-network (SAN).

Illustratively, the memory 225 contains a delivery scheduling application 227 and a two-week delivery plan 229 and the storage 230 contains historical delivery data 231, truck data 233, customer data 235, and optimization parameters 237. In one embodiment, the delivery scheduling application 227 provides a software application which allows a producer/distributor of cylinders to generate an optimized delivery schedule (i.e., two-week delivery plan 229) from a collection of data describing the delivery requirements of a set of customers and the resources available to a producer/distributor to make such deliveries. For example, the collection of data may characterize a supply chain for a cylinder distribution network, according to the data 231, 233, 235, and 237. The historical delivery data 231 may specify the orders submitted by customers in the past (e.g., over a period of one year) and the truck data 233 may describe the characteristics of a delivery fleet available to deliver cylinders to customers in the supply chain. In turn, the customer data 235 includes delivery requirements, locations, and any other constraints associated with each customer to be included in a cylinder delivery schedule. Lastly, the optimization parameters 237 describe any other constraints, or requirements for the delivery plan 229 generated by the delivery scheduling application 227 that may be appropriate or helpful in a particular case. Examples of the data elements 231, 233, 235, and 237 and the operations of the delivery scheduling application 227 are described in greater detail below.

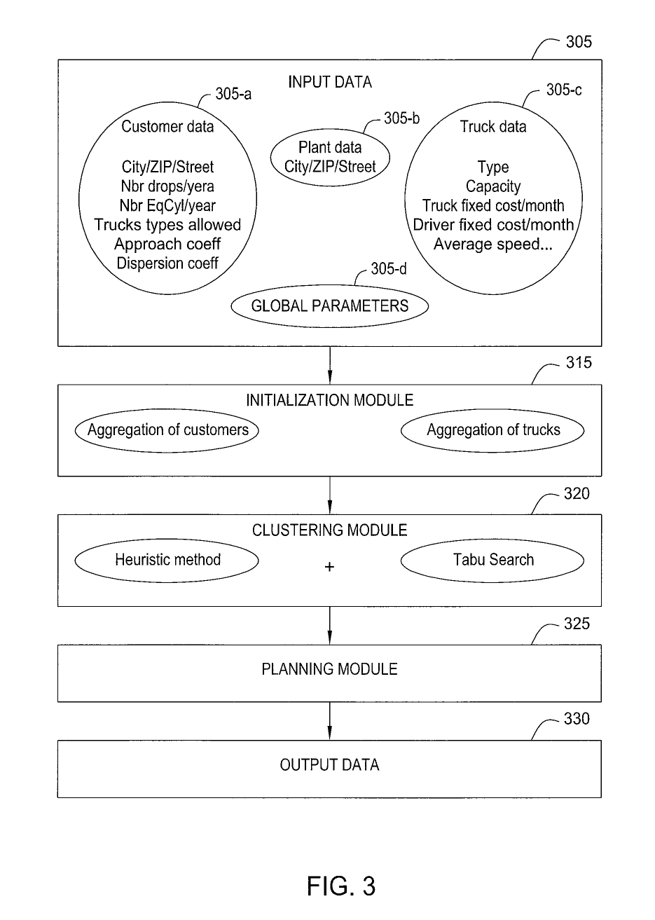

FIG. 3 further illustrates the delivery scheduling application 227 first shown in FIG. 2, according to one embodiment of the invention. As shown, the delivery scheduling application 227 includes an initialization module 315, a clustering module 320, and a planning module 325. In one embodiment, the initialization module 315 is configured to receive input data 305 and prepare it for processing by the clustering module 320 and, subsequently, the planning module 325. The input data 305 may describe the customers, trucks, and related parameters for a cylinder delivery supply chain. For example, the customer data 305-a may describe a customer according to a minimal number of times that customer needs to be visited each week, the average number of cylinders delivered to that customer per week (e.g., over the past year), the average number of drops at the customer site per week (also over the last year). Any constraints on the types of trucks accepted at the customer site (i.e., what trucks are allowed to deliver to a given customers). Of course other relevant information about a customer may be included, as appropriate or helpful in a particular case.

The truck data 305-b may include data describing a fleet of trucks available to deliver cylinders to (and retrieve cylinders from) the set of customers. For example, trucks may have a type assigned to them (e.g., based on size), which as noted, may be used to specify what truck types can be used to deliver to a given customer. The truck data may also include a capacity (i.e., the number of cylinders a truck can carry). An estimated fixed cost per week, e.g., a cost for the driver, the truck, (and any fees) and a variable cost, e.g., a cost incurred per mile/kilometer driven. A cost for each driver working hour not included in the fixed costs. An approach speed is defined as the average time required to go from a filling center to a cluster of customers and a dispersion speed is defined as an average speed to drive around to each customer in the cluster, once reached during a given delivery.

The plant data 305-c may only give the localization of the hub or plant as appropriate.

The global optimization parameters 305-d may also include a set of global information used for generating a delivery schedule. For example, the optimization parameters may include a maximum duration of a working day, the number of working days per week, total time spent at the filling plant per round trip, time spent at a customer cite per cylinder delivery, and maximum load rate of the trucks, among others. This last element allows the user to keep additional load (i.e., some number of additional cylinders) on the trucks to consider variation in customers' demands. The optimization parameters may also include a cost of an overnight stay (if permitted for a delivery schedule), a maximum distance between any two customers which allows them to be treated as an aggregated customer (i.e., two customers treated as a single aggregated customer to simply the optimization calculations), a maximum distance between two customers included in the same cluster, and a minimum distance between the filling center and a customer assigned to a multi-day round trip. As with the customer data, the truck data and optimization parameters may also include any other relevant information about a customer as appropriate or helpful in a particular case.

Additionally, the input parameters may include a partial solution (i.e., a particular set of clusters or partial delivery schedule). For example, a user may supply a set of clusters with the input data, bypassing the need for the clustering module 320 to generate a set of clusters. An intermediate approach would be where some clusters are defined by the input data 305 but others may be added by the clustering module 320.

Once received, the initialization module 315 validates the input data 305. For example, the customers, trucks, and global parameters may be checked to ensure that a complete set of data has been supplied, with the proper data types and ranges. In addition, in one embodiment, the initialization module 315 may aggregate certain trucks or customers having similar attributes. For example, in cases where a filling station is expected to supply large numbers of customers, some customers may be aggregated to reduce the number of variables passed to the clustering module 320 and planning module 325. Doing so may reduce the computation time needed to generate a delivery schedule. This may be accomplished by assigning to one cluster customers that are most likely to be grouped together in an optimal solution. For example, customers which are very close to one another and accept the same types of trucks for delivery may be grouped into one meta-customer to be processed as a single unit by the clustering module 320.

Similarly, the list of trucks available at a filling station may include multiple trucks with the same (or similar) capacity, type, and approach and dispersion speeds. These trucks do not need to be evaluated independently, as they will each lead to the same constraints or results. That is, if two trucks have certain identical (or near identical) characteristics, then considering both trucks for delivery to a given cluster becomes redundant. Instead, such groups of trucks may be aggregated as a meta-truck. Doing so limits the execution time of the clustering module 320 and the planning module 325.

Once processed, the initialization module 315 passes the input data 305 to the clustering module 320. As noted above, the clustering module 320 may group customers together in clusters. Specifically, a cluster of customers is a group of customers which will be allowed to order deliveries on a same set of days and which will be delivered by the same truck on the assigned delivery days. Generally, the clustering process leverages the fact that the round trips from the filling stations to a cluster will typically follow an consistent pattern (i.e., the actual approach speed remains relatively near the average) and the actual dispersion speed (the time required to deliver to the customers a cluster) does the same. The clustering module 320 uses a heuristic method to find a non-optimal but feasible solution, called “greedy”. Then this solution becomes optimized using the Tabu Search. Further, the clusters generated by the Greedy Algorithm and Tabu Search may be modified to maximize cluster separation. This may be necessary as the solution generated by the Tabu Search may include clusters which do not clearly define a geographic area. To address this, customers assigned to certain clusters generated by the Tabu Search may be swapped or moved to another cluster to provide clusters with a geographic separation.

The clusters generated by the clustering module 320 are passed to the planning module 325. The planning module 320 is configured to assign trucks to any aggregated trucks, and build a final planning schedule. As noted above, the final planning schedule may provide a schedule specifying which days, and which trucks, to use to deliver cylinders to each customer over a two week period. The schedule may be further broken down into a week one schedule and a week two schedule. In one embodiment, the planning module 325 may be implemented using Constraint Programming techniques. As is known, Constraint Programming is a programming approach where relations between variables are stated in the form of constraints. Constraint programming is used to provide a declarative description of a problem and an approach for solving of large, combinatorial, problems especially in areas of planning and scheduling. In context of the present invention, Examples of constraints defined for the constraint programming problem solved by the planning module 325 may include the following:
Covering Constraints: Every round trip has to be placed in the planning.
Compatibility Constraints: The truck assigned to each cluster has to be allowed to deliver to the cluster (i.e., the customers will allow the constraint type)
Availability constraints: A truck can only deliver to one cluster at a time. And the total number of working days of each truck during each of the two weeks must not exceed the maximum number of working days.
Single Week constraints: A round trip cannot be executed over two different weeks.
Precedence constraints: the (i+1)^{ith} round trip to a cluster has to start after the ith trip (i.e., different delivery round trips to the same cluster have to start at different times).
   Of course, these, and other constraints may be used as is appropriate for a particular case.

Once the planning module affects a truck to each cluster, the planning module then disaggregates any aggregated or meta-trucks. As an aggregated truck, in fact, represents multiple trucks having similar characteristics, the planning module 325 may disaggregate the trucks by affecting one of the actual trucks in an aggregation to each cluster affected a meta-truck. Otherwise, the meta-trucks affected to a given cluster could be delivered by any of the trucks represented by the aggregation, which is not the best operational solution. Thus, instead, a specific truck is affected for each cluster. The results of the planning module are returned as output data 330. Assuming the input data represented a solvable problem, the clustering module 320 generates a set of clusters partitioning the customers and a week one and week two plan describing the standard activity of a fleet of trucks over a two week period. Before returning the outputs, the customers are disaggregated and the clusters are updated. The cost forecasts of the two-week plan may be updated so that that the final affectation (i.e., assignment) of each round trip of a truck to a cluster is charged the correct global costs. Then the set of clusters and the week one and week two plans are returned as output data 330. The resulting output data 330 may be displayed and on an interface which allows the user to validate the generated solution or to make any desired manual modifications.

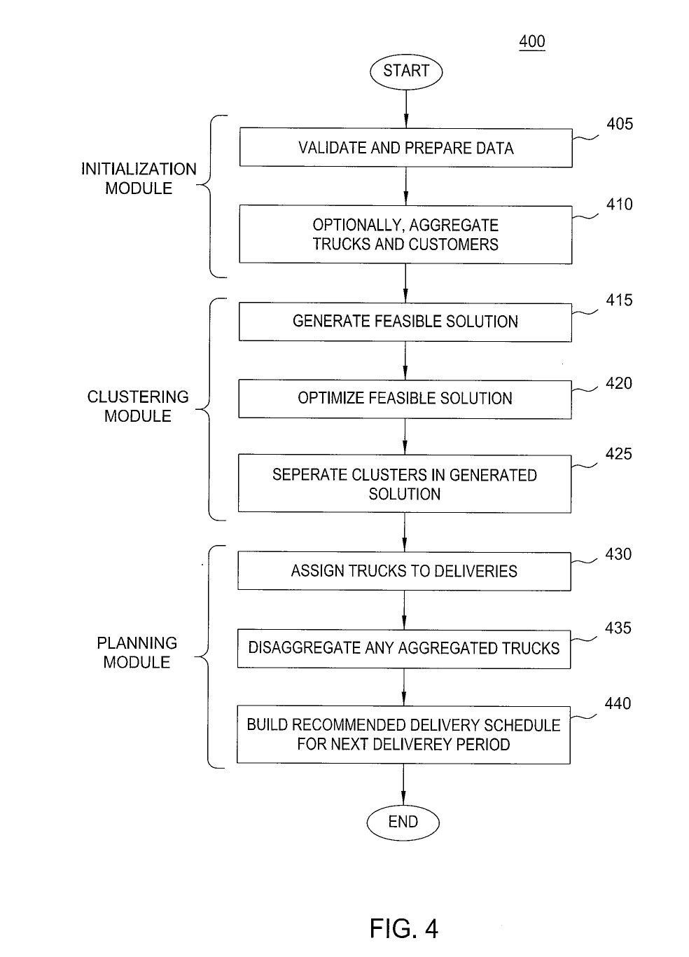

FIG. 4 illustrates a method 400 for generating a delivery schedule for a cylinder distribution network, according to one embodiment of the invention. The method 400 illustrates steps performed by the initialization module 315, the clustering module 320, and the planning module 325 to generate the delivery schedule for a cylinder distribution network. As shown, the method 400 begins at step 405, where the initialization module 315 validates and prepares the input data for processing by the clustering module. At step 410, the initialization module 315 may evaluate the customer and truck input data and aggregate customers and/or trucks as appropriate.

At step 415, the clustering module 320 generates a feasible clustering solution. In context of the present invention, feasible generally means a set of clusters that satisfy any constraints specified in the input data (e.g., a maximum distance between any two customers in a given cluster). As noted above, in one embodiment, the clustering module may generate a feasible solution using an implementation of the Greedy Algorithm. The Greedy Algorithm generates a solution by following a solution path by selecting what is best choice at each step of the solution. More formally, the Greedy Algorithm makes a locally optimal choice at each stage of solving a problem with the hope of finding the global optimum. The output of step 415 includes a set of clusters, where each cluster identifies one or more customers (or meta-customers). In one embodiment, the constraint programming approaches discussed above are used to generate a set of clusters that minimizes approach dispersion coefficients (representing an approach delivery path to reach a given cluster) and a dispersion coefficients (representing the delivery path used to distribute product to each customer assigned to a cluster).

At step 420, the clustering module 320 optimizes the results of the Greedy Algorithm. For example, clusters close to one another may be merged. Further, as noted above, in one embodiment, the clustering module 320 may optimize the clusters generated at step 415 using a Tabu Search. As is known, a Tabu Search is an algorithm that can be used for solving combinatorial optimization problems. Generally, a Tabu search uses a local or neighborhood search procedure to iteratively move from a solution x to a solution x′ in the neighborhood of x, until an exit condition is satisfied. For example, in context of the present invention, a local search may be repeatedly performed until exit criteria are satisfied. At each iteration new possible solutions are generated by, e.g., moving individual customers from one cluster to another, moving pairs of customers, or swapping customers between different clusters. With each set of moves, the best move (if resulting in a feasible solution) is selected and added to Tabu list (to prevent it from being evaluated again as a result of further moves). This solution is also evaluated to either raise or lower penalties, based on how many iterations have occurred without finding a feasible solution (raising penalties) or unfeasible solution (lowering penalties). This process is repeated until a stop condition is reached. Once the stop condition is satisfied, the best feasible solution that has been identified during the iterations of the local search is returned as a final result.

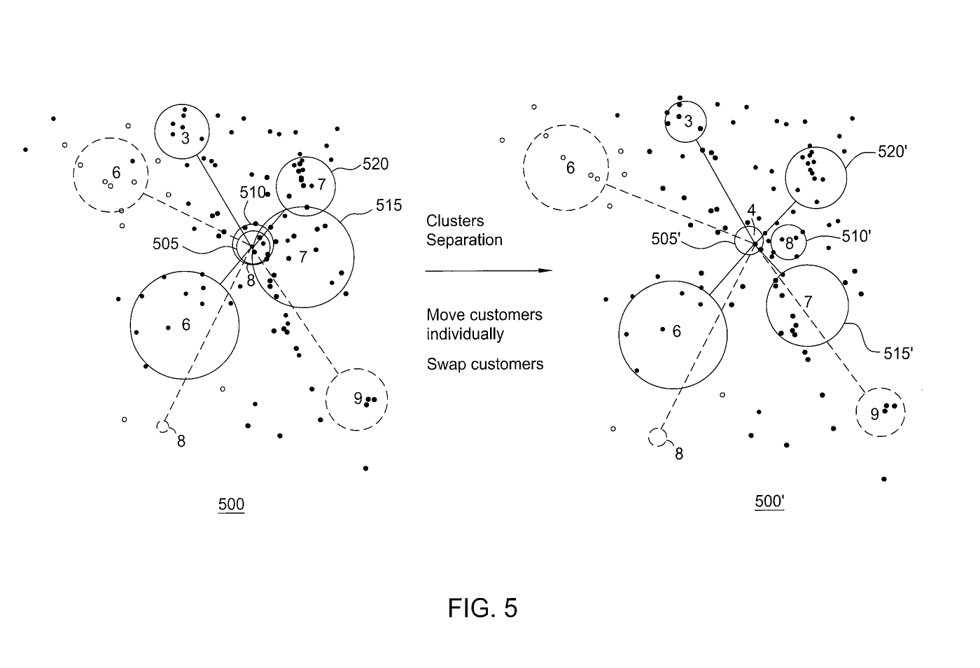

At step 425, the clusters generated by the Tabu search may be separated using a local search. For example, FIG. 5 shows an initial set of clusters 500, which includes clusters 505, 510, 515, and 520 which overlap one another to a greater or lesser degree. The local search performed at step 425 identifies customers assigned to one cluster that fall with in the dispersion radius of another cluster. Such customers may be moved individually, or swapped with customers in other clusters to create a disjoint set of clusters. This result is shown in clusters 500′, where some of the customers in clusters 505, 510, 515, and 520 have been moved, resulting in 505′, 510′, 515′, and 520′ which do not overlap.

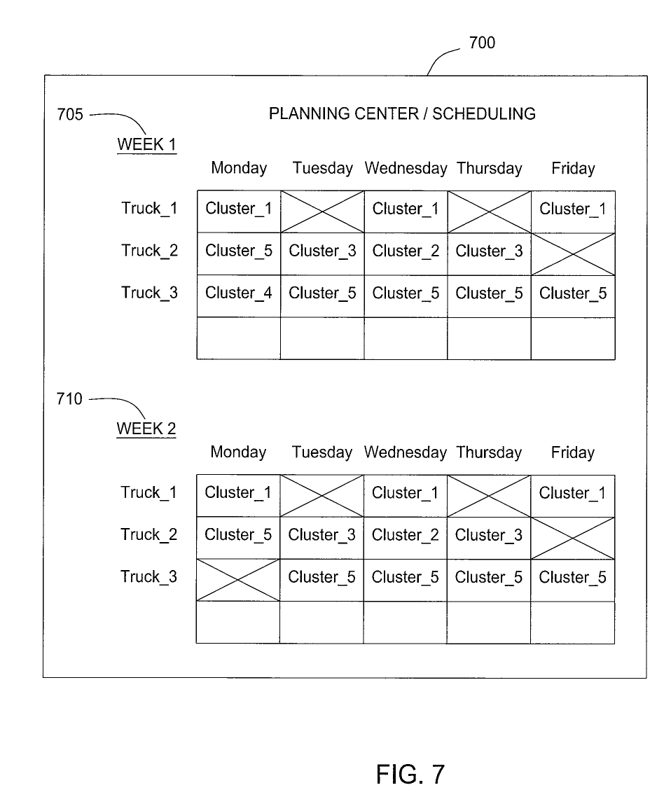

Like step 415, the output of steps 420 and 425 includes a set of clusters, where each cluster identifies one or more customers (or meta-customers). However, the Tabu search may have removed clusters, or modified the distribution of customers to the clusters and the cluster separation steps may have further modified the clusters to create clusters that do not overlap. At step 430, the planning module may assign trucks to deliver to specific clusters. For example, the planning module use a frequency delivery requirement specified for a customer to determine the number of days per week (over a two week schedule) required to satisfy the delivery requirements. Once trucks are affected (i.e., assigned) to clusters, the planning module disaggregates any aggregated trucks, allowing specific trucks to be assigned to the clusters (step 435). And at step 440, the planning module 325 builds a recommended delivery schedule for the next delivery period, e.g., a two-week plan that includes a first week delivery schedule and a second week delivery schedule. For example, FIG. 7 illustrates a two-week delivery schedule 700. As shown, three trucks (labeled 1, 2, and 3) are scheduled for delivering to five clusters in a first week 705 and four clusters a second week 710. For example, on day 1 of week 1, truck 3 delivers to cluster 4, but cluster 4 is not delivered at all in the second week. Similarly, truck 2 is scheduled to deliver to cluster 2 on Wednesday in both week 1 705 and week 2 710. Note, the delivery to each cluster is used to represent a delivery to all of the customers in that cluster.

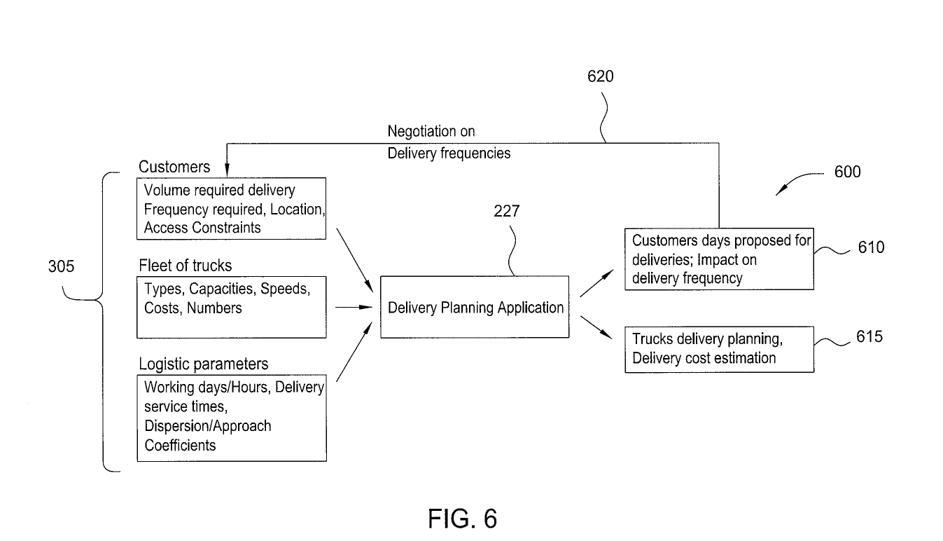

Once generated, a producer/distributor may modify the schedule as desired, as well as negotiate with customers to confirm the acceptability of the delivery days allocated to a given customer by the delivery scheduling application. That is, while customers frequently require a minimum delivery amount, they may not require the ability to order product any day of the week. Instead, by negotiating a minimum delivery frequency and allocated days of the week to satisfy that delivery frequency, the producer/distributor may significantly reduce the costs in operating the supply chain distribution network. For example, FIG. 6 illustrates a workflow 600 for a producer/distributor to organize a delivery schedule for a group of customers, according to one embodiment of the invention. As shown, the delivery/planning application 227 receives the input data 305, such as the customer data, truck data, and delivery parameters (as discussed above) and uses this information to generate a proposed delivery schedule with fixed delivery days 610 for each of the customers, as well as a forecasted cost 615 of the delivery schedule. This data, in turn, is used by the producer/distributor to negotiate delivery frequencies with the customers (shown by an arrow 620). If for whatever reasons, the proposed delivery schedule is not acceptable to a given customer, the delivery planning application 227 may be re-run with additional constraints. Doing so allows the distributor/producer to propose a new delivery schedule, while still benefiting from the reduced operational costs of using a delivery schedule which limits the delivery to customers in a given cluster to certain days of the week, organized using the computer-implemented delivery planning application described herein.

Thus, advantageously, embodiments of the invention provide a computer-implemented delivery planning application configured to generate a schedule (e.g., a two-week schedule) for delivering a commodity product to multiple customers (e.g., cylinders of refined gasses). A producer (or distributor) may periodically use the delivery planning application to optimize a cylinder delivery schedule, which, in turn, reduces overall delivery costs. Further, as the producer (or distributor) typically supplies customers pursuant to longer-term contracts, the two-week schedule can be used (and re-used) over a longer period (e.g., six months). When it comes time to prepare a new delivery schedule (e.g., due to fluctuations in existing customer demand), the delivery application may be used to generate a new schedule. Similarly, while negotiating a contract with a new customer that would need to be added to the delivery schedule, the delivery application may generate a proposed schedule that the producer may use to negotiate a set of allowed delivery dates for the new customer, helping integrate the new customer into the existing delivery schedule in an efficient manner.

It will be understood, however, that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

What is claimed is:

1. A computer-implemented method for generating a delivery schedule for a group of customers grouped by clusters, the method comprising:
receiving a set of input data specifying a set of customers, delivery vehicles, and delivery parameters for distributing a commodity product to the set of customers from one of a filling plant or a hub using direct transport to customers;
generating, from the input data, a set of one or more clusters, wherein each cluster specifies a disjoint group of one or more of the customers, wherein the disjoint group of one or more of the customers in a cluster represents a group of customers allowed to request deliveries on a common set of days of the week, and which are delivered by the same delivery vehicle on the common set of days of the week;
determining a delivery schedule for distributing the commodity product to the set of customers, wherein the delivery schedule allocates one or more days of a week for a delivery to each cluster using one of the delivery vehicles.

2. The method of claim 1, wherein the set of one or more clusters are generated according to a Greedy Algorithm.

3. The method of claim 2, wherein the set of one or more clusters are generated according to the Greedy Algorithm are further generated according to a Tabu Search.

4. The method of claim 3, further comprising:
generating, from the input data, at least one meta-customer aggregating two or more customers specified by the input data, and wherein the at least one meta customer is assigned to one of the clusters; and
prior to determining the delivery schedule, disaggregating the meta-customer.

5. The method of claim 3, further comprising:
generating, from the input data, at least one meta-delivery vehicle aggregating two or more vehicles specified by the input data, wherein at least one of the days for which a delivery is allocated to a first cluster is allocated using the meta-delivery vehicle; and
prior to determining the delivery schedule, disaggregating the meta-delivery vehicle by allocating one of the two or more aggregated delivery vehicle to the first cluster.

6. The method of claim 1, wherein determining a delivery schedule for distributing the commodity product to the set of customers comprises solving a Constraint Programming model.

7. The method of claim 1, wherein the commodity product comprises refined gases stored in cylinders.

8. A computer-readable storage medium containing a delivery scheduling application, which when executed on a processor performs an operation for generating a delivery schedule for a group of customers grouped by clusters, the operation comprising:
receiving a set of input data specifying a set of customers, delivery vehicles, and delivery parameters for distributing a commodity product to the set of customers from one of a filling plant or a hub using direct transport to customers;
generating, from the input data, a set of one or more clusters, wherein each cluster specifies a disjoint group of one or more of the customers, wherein the disjoint group of one or more of the customers in a cluster represents a group of customers allowed to request deliveries on a common set of days of the week and which are delivered by the same delivery vehicle on the common set of days of the week;
determining a delivery schedule for distributing the commodity product to the set of customers, wherein the delivery schedule allocates one or more days of a week for a delivery to each cluster using one of the delivery vehicles.

9. The computer-readable storage medium of claim 8, wherein the set of one or more clusters are generated according to a Greedy Algorithm.

10. The computer-readable storage medium of claim 9, wherein the set of one or more clusters are generated according to the Greedy Algorithm are further generated according to a Tabu Search.

11. The computer-readable storage medium of claim 10, wherein the operation further comprises:
generating, from the input data, at least one meta-customer aggregating two or more customers specified by the input data, and wherein the at least one meta customer is assigned to one of the clusters; and
prior to determining the delivery schedule, disaggregating the meta-customer.

12. The computer-readable storage medium of claim 10, wherein the operation further comprises:
generating, from the input data, at least one meta-delivery vehicle aggregating two or more vehicles specified by the input data, wherein at least one of the days for which a delivery is allocated to a first cluster is allocated using the meta-delivery vehicle; and
prior to determining the delivery schedule, disaggregating the meta-delivery vehicle by allocating one of the two or more aggregated delivery vehicle to the first cluster.

13. The computer-readable storage medium of claim 8, wherein determining a delivery schedule for distributing the commodity product to the set of customers comprises solving a Constraint Programming model.

14. The computer-readable storage medium of claim 8, wherein the commodity product comprises refined gases stored in cylinders.

15. A system, comprising:
a processor; and
a memory storing a delivery scheduling application, which when executed on the processor performs an operation for generating a delivery schedule for a group of customers grouped by clusters, the operation comprising:
receiving a set of input data specifying a set of customers, delivery vehicles, and delivery parameters for distributing a commodity product to the set of customers from one of a filling plant or a hub using direct transport to customers,
generating, from the input data, a set of one or more clusters, wherein each cluster specifies a disjoint group of one or more of the customers, wherein the disjoint group of one or more of the customers in a cluster represents a group of customers allowed to request deliveries on a common set of days of the week and which are delivered by the same delivery vehicle on the common set of days of the week, and
determining a delivery schedule for distributing the commodity product to the set of customers, wherein the delivery schedule allocates one or more days of a week for a delivery to each cluster using one of the delivery vehicles.

16. The system of claim 15, wherein the set of one or more clusters are generated according to a Greedy Algorithm.

17. The system of claim 16, wherein the set of one or more clusters are generated according to the Greedy Algorithm are further generated according to a Tabu Search.

18. The system of claim 17, wherein the operation further comprises:
generating, from the input data, at least one meta-customer aggregating two or more customers specified by the input data, and wherein the at least one meta customer is assigned to one of the clusters; and
prior to determining the delivery schedule, disaggregating the meta-customer

19. The system of claim 17, wherein the operation further comprises:
generating, from the input data, at least one meta-delivery vehicle aggregating two or more vehicles specified by the input data, wherein at least one of the days for which a delivery is allocated to a first cluster is allocated using the meta-delivery vehicle; and
prior to determining the delivery schedule, disaggregating the meta-delivery vehicle by allocating one of the two or more aggregated delivery vehicle to the first cluster.

20. The system of claim 15, wherein determining a delivery schedule for distributing the commodity product to the set of customers comprises solving a Constraint Programming model.

21. The system of claim 15, wherein the commodity product comprises refined gases stored in cylinders.
